(19) United States
(12) Patent Application Publication
(10) Pub. No.: US 2024/0313815 A1
(43) Pub. Date: Sep. 19, 2024

(54) HIGH TEMPERATURE WIRELESS TRANSCEIVER FOR AUTOMOTIVE AND OFF-ROAD AUTOMOTIVE APPLICATIONS

(71) Applicants: DANFOSS POWER SOLUTIONS II TECHNOLOGY A/S, Nordborg (DK); EATON INTELLIGENT POWER LIMITED, Dublin (DK)

(72) Inventors: Rohit Tejsingh CHAUHAN, Pune (IN); Steven Lee HUM, Minnetonka, MN (US)

(73) Assignee: DANFOSS A/S, Nordborg (DK)

(21) Appl. No.: 18/574,205

(22) PCT Filed: Jun. 29, 2022
(86) PCT No.: PCT/IB2022/056070

§ 371 Date: Dec. 26, 2023

(30) Foreign Application Priority Data
Jun. 29, 2021 (IN) 202111029169

(51) Int. Cl. H04B 1/3822; H04B 1/036

(52) U.S. Cl. CPC H04B 1/3822; H04B 1/036

(57) ABSTRACT

A microelectromechanical system (MEMS) oscillator is used in a high temperature radio frequency (RF) transceiver (e.g., a high temperature wireless transceiver) to overcome high temperature limitations of a standard RF transceiver that utilizes a crystal oscillator. The design of the high temperature RF transceiver enables it to operate at a junction temperature of up to 125 degrees Celsius making it suitable to applications where an ambient temperature of up to 105 degrees Celsius occurs. Example applications include those where the high temperature RF transceiver is mounted on a hydraulic valve, on a hydraulic valve manifold, on or a near an engine, or on a chassis of an automotive vehicle or off-road automotive vehicle.

This application is being filed on Jun. 29, 2022, as a PCT International Patent application and claims the benefit of and priority to Indian Provisional patent application No. 202111029169, filed Jun. 29, 2021, the entire disclosure of which is incorporated by reference herein in its entirety.

### TECHNICAL FIELD

The present disclosure is directed to wireless communication and, more particularly, to wireless communication transceivers that remain operable in high temperature applications experienced by automotive vehicles and off-road automotive vehicles.

### BACKGROUND

Equipment outfitted with wireless communication, e.g., Wi-Fi, Blue Tooth, etc., enables a user to monitor operating parameters of that equipment from a remote location. For example, a utility meter equipped with a wireless transceiver can transmit usage data to a mobile meter reader or a remotely located central billing system. However, in instances where the equipment and wireless transceiver are subject to extreme heat, the ability to maintain wireless transmissions can break down as components, such as a crystal oscillator, in the wireless transceiver fail under the heat. This is of particular concern in automotive and off-road automotive applications where a wireless transceiver can be located in a harsh high temperature environment where ambient temperatures can reach 105 degrees Celsius and components within a wireless transceiver can exceed 105 degrees Celsius.

### SUMMARY

According to the present disclosure, a microelectromechanical system (MEMS) oscillator is used in a high temperature radio frequency (RF) transceiver (e.g., a high temperature wireless transceiver) to overcome high temperature limitations of a standard RF transceiver that utilizes a crystal oscillator. The design of the high temperature RF transceiver enables it to operate at a junction temperature of up to 125 degrees Celsius making it suitable to applications where an ambient temperature of up to 105 degrees Celsius occurs. Example applications include those where the high temperature RF transceiver is mounted on a hydraulic valve, on a hydraulic valve manifold, on or a near a vehicle engine, or on a chassis of an automotive vehicle or off-road automotive vehicle.

A first aspect of the present disclosure is directed to a high temperature wireless transceiver. The high temperature wireless transceiver includes a printed circuit board (PCB) having a microelectromechanical system (MEMS) oscillator, an antenna, and a radio frequency controller in communication with the MEMS oscillator and antenna. The high temperature wireless transceiver is manufactured with a junction temperature rating of at least 125 degrees Celsius.

Another aspect of the present disclosure is directed to a hydraulic valve manifold with wireless communication capabilities. The hydraulic valve manifold includes a plurality of solenoid-controlled hydraulic valves and a control system that is mounted on the hydraulic valve manifold. The control system includes a controller that directs operation of a solenoid coil of the solenoid-controlled valves and stores one or more real-time operating parameters of the hydraulic valve manifold. The control system additionally includes a wireless transceiver in communication with the controller. The wireless transceiver has a junction temperature rating of at least 125 degrees Celsius and includes a microelectromechanical system (MEMS) oscillator. The wireless transceiver transmits the one or more real-time operating parameters.

Still another aspect of the present disclosure is directed to a method of reporting an operating parameter of a hydraulic system. The hydraulic system includes a hydraulic valve manifold, having a plurality of hydraulic valves, that controls operation of construction lift machinery. The method includes: (a) sensing an operating parameter of the hydraulic system; (b) storing the sensed operating parameter in a memory of a controller; and (c) wirelessly transmitting the stored operating parameter with a wireless transceiver in communication with the controller, the wireless transceiver having a microelectromechanical system (MEMS) oscillator and the wireless transceiver having a junction temperature rating of at least 125 degrees, wherein both the controller and the wireless transceiver are components of an electrical control system mounted on the hydraulic valve manifold.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a schematic of an automotive and off-road automotive wireless communication system for high temperature applications.

FIG. 2 is a simplified schematic of a solenoid actuated valve with a controller and a high temperature radio frequency (RF) transceiver mounted atop a solenoid coil connector.

FIG. 3 is a schematic of a high temperature RF transceiver.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. Further, for example, the term “including” shall mean “including, but not limited to.”

According to the present disclosure, a microelectromechanical system (MEMS) oscillator is used in a high temperature radio frequency (RF) transceiver (e.g., a high temperature wireless transceiver) to overcome high temperature limitations of a standard RF transceiver that utilizes a crystal oscillator. The design of the high temperature RF transceiver enables it to operate at a junction temperature of up to 125 degrees Celsius making it suitable to applications where an ambient temperature of up to 105 degrees Celsius occurs. Junction temperature or transistor junction temperature is a well-known concept by those skilled in the art and can also be characterized as the operating temperature. Example applications include those where the high temperature RF transceiver is mounted on a hydraulic valve, on a hydraulic valve manifold, on or a near a vehicle engine, or on a chassis of an automotive vehicle or off-road automotive vehicle.

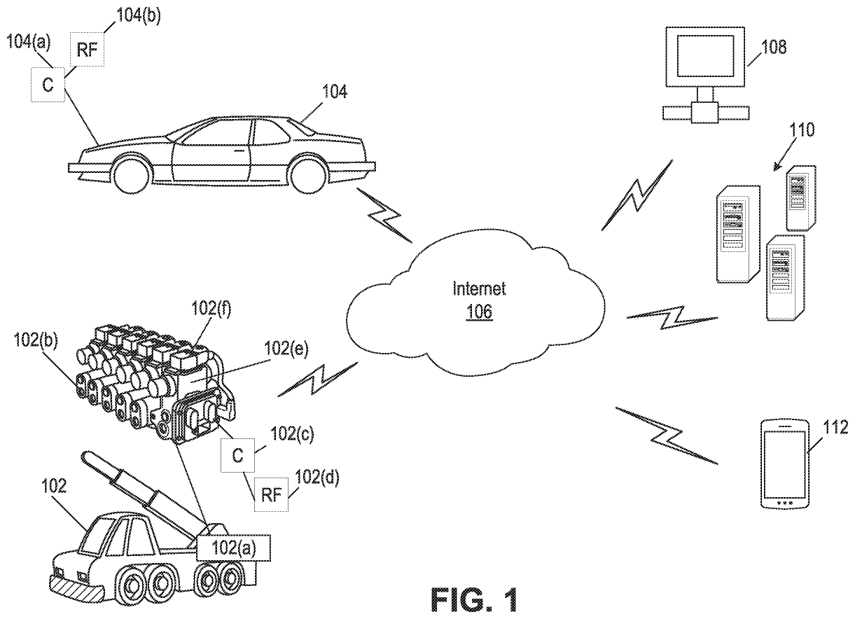

Referring to FIG. 1, a simplified example of an automotive and off-road automotive wireless communication system according to the present disclosure is illustrated. The system includes an off-road vehicle 102 and a vehicle 104 in wireless communication (e.g., WiFi, Bluetooth, Zigbee, etc.), via the internet 106, with one or more computing devices that can include, for example, a personal computer 108, one or more server computers 110, and a smart phone 112. The illustrated off-road vehicle 102 is a boom lift; however, it should be appreciated that the off-road vehicle is not limited to the illustrated embodiment and can include any off-road vehicle (e.g., any type of vehicle that is capable of driving on and off paved or gravel surfaces). In certain embodiments, the off-road vehicle 102 comprises a construction lift vehicle that includes a hydraulic system to control lifting machinery associated with the vehicle, e.g., a hydraulic system for controlling actuators that position the arms of a boom lift or position the fork of a forklift. Examples of a construction lift vehicle include, but are not limited to, a boom lift, a cherry picker, a scissor lift, a forklift, and a winch.

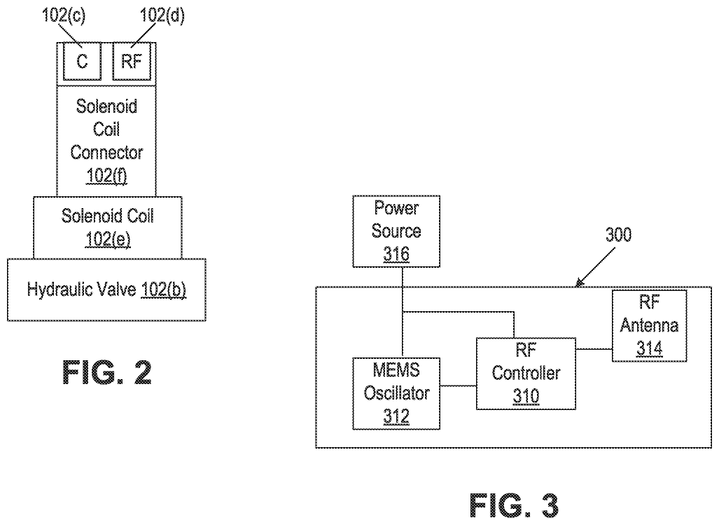

The off-road vehicle 102 includes a hydraulic system that includes a hydraulic valve manifold 102(a) including one or more hydraulic valves 102(b) that are solenoid coil 102(e) actuated responsive to a controller 102(c) executing instructions stored in a memory to regulate the flow of hydraulic fluid through the one or more hydraulic valves 102(b). In certain embodiments, the controller 102(c) is mounted directly on the hydraulic valve manifold 102(a) or directly mounted on one of the hydraulic valves 102(b) (e.g., atop a solenoid coil connector 102(f), see FIG. 2), while in other embodiments, the controller 102(c) is mounted remotely from the hydraulic valve manifold 102(a) such as on a chassis of the off-road vehicle 102 near the hydraulic valve manifold 102(a).

The hydraulic system of the off-road vehicle 102 additionally includes a radio frequency (RF) transceiver 102(d) that is in communication with the controller 102(c) to transmit data and receive data related to the operation of the hydraulic system. For example, the RF transceiver 102(d) may transmit data related to the sensed position of one or more actuators moving the arms of the illustrated boom lift, may transmit the sensed pressure of each of the at least two hydraulic valves or may transmit warning or errors associated with the operation of the hydraulic system. In another example, the RF transceiver 102(d) may receive a program update for the controller 102(c). The RF transceiver 102(d) may be a component distinct from the controller 102(c) (e.g., an RF module) or incorporated into the controller 102(c) itself. If a distinct component, the RF transceiver 102(d) is generally positioned proximate the controller 102(c) and is correspondingly mounted directly on the hydraulic valve manifold 102(a), directly on one or more of the hydraulic valves 102(b) or remotely mounted from the hydraulic valve manifold 102(a) such as on a chassis of the off-road vehicle 102. In certain embodiments, the RF transceiver 102(d) and controller 102(c) are connected via traces of a shared printed circuit board (PCB) and/or are contained in a singular housing for mounting.

Due to the positioning of the controller 102(c) and RF transceiver 102(d), the electronics of the controller 102(c) and RF transceiver 102(d) are subject to ambient temperatures as well heat generated by the solenoid-actuated hydraulic valves 102(b) and/or hydraulic valve manifold 102(a). For example, a controller 102(c) and RF transceiver 102(d) mounted atop a solenoid coil connector 102(f), as shown in FIG. 2, may experience increased temperatures due to self-heating (e.g., power loss in a solenoid current driver) and thermal radiation caused by solenoid coil heat. As such, the controller 102(c) and RF transceiver 102(d) are subjected to temperatures of up to 105 degrees Celsius, with electronic components of the controller 102(c) and RF transceiver 102(d) being subjected to temperatures greater than 105 degrees Celsius.

The system additionally includes an automotive vehicle 104 having a controller 104(a) and a radio frequency (RF) transceiver 104(b) incorporated within or in communication with the controller 104(a); the controller 104(a) executes programmed instructions stored in a memory causing the automotive vehicle to perform various functions, to report operational data that is transmitted by the RF transceiver 104(b), and to receive transmitted data via the RF transceiver 104(b). Within an automotive vehicle (e.g. a vehicle designed for paved roads), the controller 104(a) and RF transceiver 104(b) are mounted near an engine of the automotive vehicle where the components of the controller 104(a) and RF transceiver 104(b) can also be subject to temperatures that exceed 105 degrees Celsius.

Whether mounted near an engine or on or near a hydraulic valve manifold, the controllers 102(c), 104(a) and RF transceivers 102(d), 104(b) can be subject to extreme operating temperatures, e.g. an ambient temperature of up to 105 degrees Celsius, causing the electronic components of the controller and RF transceiver to be subject to junction temperatures exceeding 105 degrees Celsius. As such, the printed circuit board (PCB), electronics of the controllers 102(a), 104(a), and RF transceivers 102(b), 104(b) should be designed with an electronic component junction temperature rating (e.g., highest operating temperature of the semiconductor in an electronic device) of 125 degrees Celsius. Electronic controllers with standard automotive grade components meet this operating parameter. However, currently available wireless transceivers are unable to meet this operating parameter.

More specifically, currently available RF transceivers, which generally include an RF controller chip, antenna, a memory (if needed), and a crystal oscillator, are rated with a junction temperature of 85 degrees or at most 105 degrees Celsius. In applications demanding an operating temperature of greater than 105 degrees Celsius, such as in the instance of an off-road vehicle with an RF transceiver installed directly on or near a hydraulic valve manifold or vehicle chassis, or in the instance of an RF transceiver mounted near a vehicle engine, the crystal oscillator will have a significant reduction in performance and reliability.

To overcome the limitations of an RF transceiver utilizing a crystal oscillator, a high temperature RF transceiver 300 of the present disclosure, which is illustrated in FIG. 3, utilizes a microelectromechanical system (MEMS) oscillator that is suitable for use in conditions where electronics may be subject to temperatures up to 125 degrees Celsius (e.g., suitable for use as RF transceiver 102(b) and 104(b)). As such, the RF transceiver has a junction temperature rating of 125 degrees Celsius.

As shown, the high temperature RF transceiver 300 generally includes an RF controller 310 enabling WiFi and Bluetooth wireless communications through use of a MEMS oscillator 312 and an antenna 314; an external power source 316 supplies power to the RF controller 310 and MEMS oscillator 312. A MEMS oscillator is an electrostatic transduction-based timing device that generates highly stable reference frequencies which are used to define radio frequencies. The MEMS oscillator is designed to and capable of withstanding temperatures at which crystal oscillators will fail. In this RF transceiver 300, the selected components enable a junction temperature rating of at least 125 degrees Celsius. In certain embodiments, the MEMS oscillator is a SiT1618B MEMS oscillator available from SiTime Corp (Santa Clara, CA). In certain embodiments, the antenna of the transceiver is a PCBA (printed circuit board assembly) based antenna that is operable at 125 degrees Celsius or a ceramic chip-based antenna operable at 125 degrees Celsius; other antennas operable at 125 degrees Celsius are also possible.

In a transmit operation of the RF transceiver, the MEMS oscillator produces a signal that is encoded with data (e.g., data supplied by a controller such as controller 102(c), 104(a)), packetized by the RF controller 310 according to a desired transmission protocol such as WiFi or Bluetooth, and transmitted by the antenna 314. In a receive operation of the RF transceiver, the antenna 314 receives a wireless transmission and the RF controller 310 operates to de-packetize the transmission to obtain data that is suppled to a controller (e.g., controller 102(c), 104(a)). In certain embodiments, the RF transceiver comprises an RF module incorporating all components for operation on a single PCB that can be embedded within a larger electronic system.

A high temperature RF transceiver utilizing a MEMS oscillator permits wireless communication from, and to, high temperature locations where wireless communication was not previously possible. For example, providing RF communication to a hydraulic system manifold controller, e.g., controller 102(c), enables a user access to critical operating parameters of the hydraulic system in real time (e.g., operating parameters of the solenoid coils, operating parameters associated with the hydraulic valves such as pressure, flow rates, etc., or any operating capable of being sensed or inferred from operation of the hydraulic system or manifold) through any suitable computer device operating system, e.g. Windows, iOS, Android, etc. Further, providing RF communication to a hydraulic system manifold controller enables controller firmware and diagnostics to be easily uploaded and downloaded, respectively.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A high temperature wireless transceiver, comprising:
a printed circuit board (PCB) including:
a microelectromechanical system (MEMS) oscillator;
an antenna; and
a radio frequency controller in communication with the MEMS oscillator and the antenna,
wherein the high temperature wireless transceiver has a junction temperature rating of greater than 105 degrees Celsius.

2. The high temperature wireless transceiver of claim 1, wherein the high temperature wireless transceiver comprises a hydraulic valve manifold-mounted high temperature wireless transceiver.

3. The high temperature wireless transceiver of claim 2, wherein the hydraulic valve manifold comprises a hydraulic valve manifold of an off-road vehicle.

4. The high temperature wireless transceiver of claim 3, wherein the high temperature wireless transceiver is in communication with a controller controlling operation of the hydraulic valve manifold of the off-road vehicle.

5. The high temperature wireless transceiver of claim 4, wherein the controller comprises a hydraulic valve manifold-mounted controller.

6. The high temperature wireless transceiver of claim 1, wherein the high temperature wireless transceiver comprises a vehicle chassis-mounted high temperature wireless transceiver.

7. The high temperature wireless transceiver of claim 6, wherein the vehicle chassis-mounted high temperature wireless transceiver is mounted proximate an engine of a vehicle.

8. The high temperature wireless transceiver of claim 6, wherein the vehicle chassis-mounted high temperature wireless transceiver is mounted proximate a hydraulic valve manifold mounted on the chassis.

9. The high temperature wireless transceiver of claim 1, wherein the high temperature wireless transceiver has a junction temperature rating of at least 125 degrees Celsius.

10. A hydraulic valve manifold with wireless communication capabilities, comprising:
a plurality of solenoid-controlled hydraulic valves;
a control system mounted on the hydraulic valve manifold, the control system including:
a controller that directs operation of a solenoid coil of the plurality of solenoid-controlled hydraulic valves and that stores one or more real-time operating parameters of the hydraulic valve manifold; and
a wireless transceiver in communication with the controller, the wireless transceiver having a junction temperature rating of at least 105 degrees Celsius and the wireless transceiver including a microelectromechanical system (MEMS) oscillator.

11. The hydraulic valve manifold of claim 10, wherein the hydraulic valve manifold comprises a hydraulic valve manifold of an off-road vehicle.

12. The hydraulic valve manifold of claim 10, wherein the hydraulic valve manifold is a construction lift machinery hydraulic valve manifold.

13. The hydraulic valve manifold of claim 10, wherein the hydraulic valve manifold comprises a vehicle-mounted hydraulic valve manifold.

14. The hydraulic valve manifold of claim 10, wherein the wireless transceiver has a junction temperature rating of at least 125 degrees Celsius.

15. A method of reporting an operating parameter of a hydraulic system, wherein the hydraulic system is used in operation of construction lift machinery through use of a hydraulic valve manifold having a plurality of hydraulic valves, the method comprising:
sensing an operating parameter of the hydraulic system;
storing the sensed operating parameter in a memory of a controller;
wirelessly transmitting the stored operating parameter with a wireless transceiver in communication with the controller, the wireless transceiver having a microelectromechanical system (MEMS) oscillator and the wireless transceiver having a junction temperature rating of greater than 105 degrees Celsius,
wherein both the controller and the wireless transceiver are components of an electrical control system mounted on the hydraulic valve manifold.

16. The method of claim 15, wherein the operating parameter comprises a pressure or a flow rate of the hydraulic system.

17. The method of claim 15, wherein the high temperature wireless transceiver has a junction temperature rating of at least 125 degrees Celsius.
